(19) United States
(12) Patent Application Publication
(10) Pub. No.: US 2026/0115920 A1
(43) Pub. Date: Apr. 30, 2026

(54) COLLISION PREVENTION SAFETY CONTROL SYSTEM

(71) Applicant: BRILS Co., Ltd., Incheon (KR)

(72) Inventor: Jin JEON, Incheon (KR)

(21) Appl. No.: 18/945,201

(22) Filed: Nov. 12, 2024

(30) Foreign Application Priority Data
Oct. 30, 2024 (KR) 10-2024-0151252

(51) Int. Cl. B25J 9/16; B25J 15/06; B65G 43/00; B65G 61/00

(52) U.S. Cl. CPC B25J 9/1676; B25J 9/1697; B25J 15/0616; B65G 43/00; B65G 61/00

(57) ABSTRACT

In a collision prevention safety control system devised to prevent a collision by precisely controlling an automatic operation of a logistics transport and loading system and by maintaining a safety distance from a worker and an obstacle, the collision prevention safety control system includes a logistics transport and loading system for automatically transporting and loading the transport object, and a collision prevention device that controls an operation of the logistics transport and loading system.

### CROSS REFERENCE TO RELATED APPLICATION

This application claims priority from Republic of Korea Patent Application No. 10-2024-0151252, filed on Oct. 30, 2024, which is hereby incorporated by reference in its entirety.

### BACKGROUND

### Field

The present disclosure relates to a collision prevention safety control system, and more specifically, relates to a collision prevention safety control system devised to prevent a collision by precisely controlling an automatic operation of a logistics transport and loading system and by maintaining a safety distance from a worker and an obstacle.

### Description of Related Art

A collision prevention safety control system is widely used to protect safety of a worker and to improve reliability of a logistics system. In the existing logistics system, transport equipment is mainly operated, based on a preset path, but there is a limit in effectively controlling a risk of collision with an obstacle or a worker which occurs on a real-time basis due to unpredictability of a work environment. To solve this problem, a collision prevention device that controls an operation speed or a path on a real-time basis has been developed, and in particular, a safety control system using 3D vision recognition and a collision detection sensor has been studied.

Meanwhile, the above-described background technology is technical information owned by the inventor to derive the present disclosure or acquired by the inventor in a process of deriving the present disclosure, and cannot necessarily be a publicly known technology disclosed to the general public prior to an application of the present disclosure.

The present disclosure is a result of the Korea Patent Strategy Development Institute's government-led R&D full-cycle IP solution support project (Contract No. 24CC01P033).

Patent Document 0001: Korean Patent No. 10-2422251 (Published on Jul. 19, 2022) and Patent Document 0002: Korean Patent No. 10-1779296 (Published on Sep. 26, 2017) are examples in the related art.

### SUMMARY

One aspect of the present disclosure provides a collision prevention safety control system that ensures safety of a worker during a process of logistics transport and loading, maintains work continuity through real-time collision prevention, and to improve efficiency of a logistics system.

A technical aspect of the present disclosure is not limited to the above-described technical aspect, and other technical aspects not described herein will be clearly understood by those skilled in the art from the description below.

A collision prevention safety control system according to one embodiment of the present disclosure includes a logistics transport and loading system for automatically transporting and loading a transport object, and a collision prevention device that controls an operation of the logistics transport and loading system in view of a probability of collision.

In one embodiment, the collision prevention device may control the operation of the logistics transport and loading system in view of a probability of collision between a transport robot forming the logistics transport and loading system to transport and load the transport object and the worker or the obstacle existing within a movement range of the transport robot.

In one embodiment, the collision prevention device may control the operation of the logistics transport and loading system in view of the probability of collision between the transport object under transportation after being picked up by the transport robot and the worker or the obstacle existing within the movement range of the transport robot.

In one embodiment, the collision prevention device may three-dimensionally recognize a shape of the transport object, and thereafter, may monitor the probability of collision between the transport object and the worker or the obstacle on a real-time basis.

In one embodiment, the collision prevention device may recognize shapes of the transport object, the worker, and the obstacle, based on 3D vision recognition using a 3D vision camera.

In one embodiment, the collision prevention device may confirm occurrence of the collision by detecting on a real-time basis whether an impact to the transport robot or the transport object occurs during a process in which the transport object is transported by the transport robot, or may confirm the occurrence of the collision through tracking recognition of a change in a fastening pressure of a gripping portion provided in the transport robot to fasten the transport object.

In one embodiment, the collision prevention device may confirm the occurrence of the collision through change tracking of a fastening pressure of the gripping portion by using pressure information provided on a real-time bases from a pressure monitoring sensor installed in the gripping portion to detect a change in the fastening pressure of the transport object on a real-time basis.

In one embodiment, the collision prevention device may control a transport speed of the transport object transported by the logistics transport and loading system in response to characteristics including a weight of the transport object.

In one embodiment, the collision prevention device may set a collision prevention safety area according to the transport speed of the transport object so that the collision with the transport robot or the transport object does not occur in a case of emergency braking.

In one embodiment, in order to prevent the collision caused by transport inertia of the transport object in a case of emergency braking, the collision prevention device may reduce the transport speed of the transport object transported by the logistics transport and loading system or widely sets the collision prevention safety area as the weight of the transport object is heavier.

In one embodiment, the collision prevention device may setting the collision prevention safety area by estimating an area of the transport object, based on a suction pressure distribution of each of a plurality of suction cups installed in an n*n row along a bottom surface of the gripping portion to fasten the transport object by using a position of the center of gravity and a negative pressure of the transport object fastened to the gripping portion.

In one embodiment, the collision prevention device may set the collision prevention safety area which is an area for preventing the collision during transport of the transport object fastened to the gripping portion provided in the transport robot, in view of a probability of falling-down of the transport object.

In one embodiment, the collision prevention device may widely set the collision prevention safety area as the probability of falling-down of the transport object fastened to the gripping portion is higher.

In one embodiment, the collision prevention device may analyze the probability of falling-down of the transport object fastened to the gripping portion in view of at least one factor of a suction leak degree of the suction cups and a surface texture of the transport object, and thereafter, may widely set the collision prevention safety area as the probability of falling-down is higher.

According to one aspect of the present disclosure described above, the probability of collision with the worker or the obstacle existing within the movement range of the transport robot may be monitored on a real-time basis, and a risk of collision can be minimized by executing an immediate braking command or a path correction command when an unexpected obstacle or worker is detected.

In addition, since a movement path and a speed may be adjusted in view of a weight and a volume of the transport object, both safety and work efficiency are improved. In addition, through a 3D vision recognition technology, shapes of the worker and the obstacle s well as the transport object may be accurately recognized, and the probability of collision may be predicted in advance. The safety is further improved by adjusting the path or temporarily stopping the operation when necessary.

In addition, the probability of collision may be quickly determined by detecting whether an impact to the transport robot and the transport object occurs on a real-time basis, and transport safety may be ensured by tracking a change in the fastening pressure of the gripping portion and by issuing a warning signal when a fastening state is unstable.

In addition, the safety of the worker and the surrounding environment may be enhanced by analyzing the probability of falling-down of the transport object and setting the collision prevention safety area. In this manner, safety accidents may be prevented in logistics sites, and a smooth progress of transport work may be supported.

Advantageous effects of the present disclosure are not limited to the above-described advantageous effects, and the present disclosure may include various advantageous effects within the scope obvious to those skilled in the art from the contents described below.

### BRIEF DESCRIPTION OF THE DRAWING

FIG. 1 is a diagram showing a schematic configuration of a collision prevention safety control system according to one embodiment of the present disclosure.

FIGS. 2 and 3 are diagrams showing a schematic configuration of a logistics transport and

loading system according to one embodiment of the present disclosure.

FIG. 4 is a perspective view showing a state where a gripping portion is connected to a robot arm according to one embodiment.

FIG. 5 is a diagram shown at an angle different from an angle in FIG. 4.

FIG. 6 is a diagram in which some of components of the gripping portion in FIG. 4 are omitted to show internal components of the gripping portion in more detail.

FIG. 7 is a diagram showing a state where a gripping module moves in repose to an operation of a first hydraulic module in the gripping portion in FIG. 6.

FIG. 8 is an enlarged view of a portion in FIG. 7.

FIG. 9 is a diagram shown at an angle different from an angle in FIG. 8.

FIG. 10 is a diagram expressing a state where the gripping portion according to one embodiment grips and suctions an object.

FIG. 11 is a diagram showing the gripping portion according to one embodiment.

FIG. 12 is a diagram showing examples in which the object is incorrectly fastened by the suction cup of the gripping portion

FIG. 13 is a diagram showing examples in which the object is correctly fastened by the suction cup of the gripping portion.

FIG. 14 is a diagram showing examples of methods for fastening a transport object by using a transport robot.

FIG. 15 is a diagram showing a suction gripper in the related art.

### DETAILED DESCRIPTION

Detailed description of the present disclosure described below refers to the accompanying drawings that show specific embodiments for embodying the present disclosure. The embodiments will be described in sufficient detail to enable a person skilled in the art to embody the present disclosure. It should be understood that various embodiments of the present disclosure are not necessarily mutually exclusive even though the embodiments are different from each other. For example, with regard to one embodiment, specific shapes, structures, and characteristics which are described herein may be implemented in other embodiments without departing from the concept and the scope of the present disclosure. In addition, it should be understood that positions or disposition of individual components within each disclosed embodiment may be changed without departing from the concept and the scope of the present disclosure. Accordingly, the detailed description of the present disclosure described below is not taken in a limiting sense, and the scope of the present disclosure is limited only by the appended claims, along with the full scope equivalent to the appended claims, if the scope of the present disclosure is properly described. Like reference numerals in the drawings designate the same or similar functions in various aspects.

Hereinafter, preferred embodiments of the present disclosure will be described in more detail with reference to the drawings.

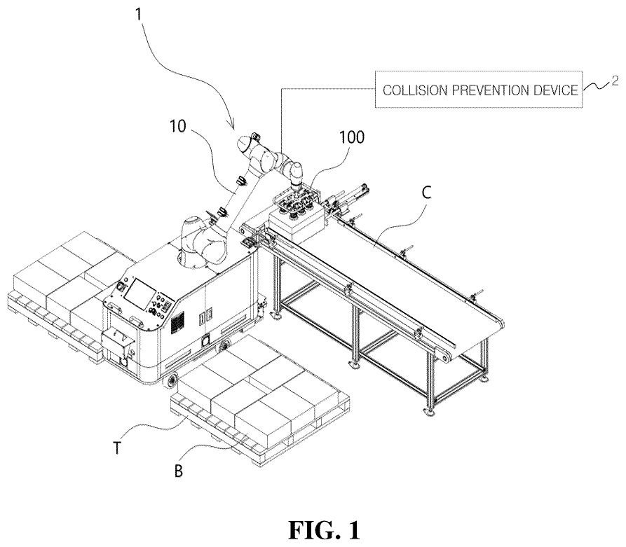

FIG. 1 is a diagram showing a schematic configuration of a collision prevention safety control system according to one embodiment of the present disclosure.

Referring to FIG. 1, the collision prevention safety control system according to one embodiment of the present disclosure includes a logistics transport and loading system (1) and a collision prevention device (2).

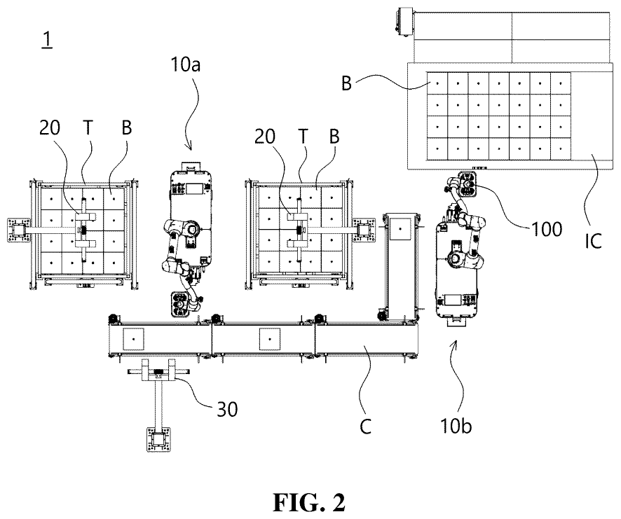

The logistics transport and loading system (1) corresponds to a system constructed in a factory or the like to automatically transport and load a transport object described later in FIG. 2 and subsequent drawings, and each component forming the system will be described later in FIG. 2 and subsequent drawings.

The collision prevention device (2) corresponds to a control unit for controlling an operation of the logistics transport and loading system (1) in view of a probability of collision.

The collision prevention device (2) according to one embodiment of the present disclosure may precisely control an operation of the logistics transport and loading system (1) by monitoring and analyzing the probability of collision between a transport robot (10) forming the logistics transport and loading system (1) for transporting and loading the transport object and a worker or an obstacle existing within a movement range of the transport robot (10) on a real-time basis.

The transport robot (10) moves along a preset path or a path instruction received on a real-time basis, and when an unexpected obstacle or a worker is detected on the path, the collision prevention device (2) minimizes a risk of collision by transmitting an immediate braking command or a path correction command to the transport robot (10). In addition, the transport robot (10) automatically resumes transport work after the obstacle is removed, and maintains continuity of a logistics transport process.

The collision prevention device (2) according to one embodiment of the present disclosure may precisely control an operation of the logistics transport and loading system (1) in view of a probability of collision between the transport object and the worker or the obstacle within the movement range of the transport robot (10) while the transport robot (10) moves after picking up the transport object.

The transport robot (10) adjusts a movement path and a speed depending on a weight and a volume of the transport object, and the collision prevention device (2) monitors a distance and a position of the worker and the obstacle on the movement path on a real-time basis. In this case, the collision prevention device (2) immediately issues a warning signal or controls the robot to reduce the speed or temporarily stop when a risk of collision is expected. In this manner, safety of the worker is ensured, and damage to the transport object is prevented.

The collision prevention device (2) according to one embodiment of the present disclosure may three-dimensionally recognize ae shape of the transport object, may identify an exact size and an exact position of the transport object, and may monitor the probability of collision between the transport object and the worker or the obstacle on a real-time basis.

Based on 3D shape information of the transport object, the collision prevention device (2) more precisely analyzes the probability of collision caused by a protruding portion or an irregular shape of the transport object, evaluates a positional relationship with the worker or the obstacle on the movement path, and controls an operation speed of the transport robot (10) or issues a temporary stop command to the transport robot (10) when necessary. In this manner, safety is ensured by preventing an unexpected collision in advance.

The collision prevention device (2) according to one embodiment of the present disclosure may accurately recognize shapes of the transport object, the worker, and the obstacle through 3D vision recognition using a 3D vision camera.

The 3D vision camera detects not only a 3D shape of the transport object but also the size and the position of the worker and the obstacle on a real-time basis, and based on this detection, the collision prevention device (2) comprehensively analyzes the path of the transport robot (10) and the surrounding environment to predict the probability of collision in advance. When necessary, the collision prevention device (2) adjusts the movement path of the transport robot (10) or temporarily stops the operation to prevent a risk of collision and enhance the safety.

The collision prevention device (2) according to one embodiment of the present disclosure may detect on a real-time basis whether an impact to the transport robot (10) or the transport object occurs during a process in which the transport robot (10) transports the transport object to determine whether the collision occurs, or may confirm whether the collision occurs by tracking a change in a fastening pressure of a gripping portion (100) provided in the transport robot (10) to fasten the transport object.

When the impact to the transport robot (10) or the transport object occurs, the collision prevention device (2) may analyze corresponding impact data to immediately cope with the impact. When there is a high probability of collision, the collision prevention device (2) stops the operation of the transport robot (10) or adjusts the speed to prevent the collision. In addition, the collision prevention device (2) continuously tracks a change in the fastening pressure of the gripping portion (100). When a fastening state of the transport object is changed or an abnormal pressure is detected, the collision prevention device (2) warns a user of the probability of collision, and issues a required control command to ensure the safety.

The collision prevention device (2) according to one embodiment of the present disclosure may confirm whether the collision occurs by using pressure information provided on a real-time basis from a pressure monitoring sensor installed in the gripping portion (100) to detect a change in the fastening pressure of the transport object on a real-time basis, and by to tracking the change in the fastening pressure of the gripping portion (100).

The pressure monitoring sensor detects a minute pressure change occurring during a fastening process of the transport object, and the collision prevention device (2) analyzes stability of a fastening state on a real-time basis, based on this detection. When the fastening pressure exceeds a set range, the collision prevention device (2) determines that the transport object is unfastened an due to external impact or the like, and immediately transmits a warning signal to the transport robot (10) or stops the operation to prevent the probability of collision. In addition, a safe and stable transport environment is maintained by detecting a change in the fastening state through the real-time pressure monitoring.

The collision prevention device (2) according to one embodiment of the present disclosure may control a transport speed of the logistics transport and loading system (1) in accordance with various characteristics including a weight of the transport object.

When the weight of the transport object is heavy or unbalanced, the collision prevention device (2) automatically lowers the transport speed to prevent a safety accident that may occur due to an excessive speed, and ensures a safe movement of the transport object. On the other hand, when the weight of the transport object is light, the risk of collision may be reduced. Therefore, the collision prevention device (2) efficiently adjusts the transport speed to optimize the transport speed of logistics. Through the speed control, the logistics transport and loading system (1) may efficiently cope with collision with various transport objects.

The collision prevention device (2) according to one embodiment of the present disclosure may set a collision prevention safety area in accordance with the transport speed of the transport object to prevent the collision with the transport robot (10) or the transport object in a case of emergency braking.

As the transport speed is higher, the probability of collision becomes higher. Therefore, the collision prevention device (2) sets a proper safety area in accordance with to the transport speed, and maintains a safety distance around the transport robot (10). In this manner, even in a case of braking in an emergency situation, the collision with the transport object or the worker may be prevented. When the worker or the obstacle is detected within the safety area, the collision prevention device (2) immediately issues a warning signal or reduces the speed to reduce the risk of collision, and secures a safe braking distance in case of emergency braking.

In order to prevent the collision caused by transport inertia of the transport object in a case of emergency braking, the collision prevention device (2) according to one embodiment of the present disclosure may reduce the transport speed of the logistics transport and loading system (1) or may widely set the collision prevention safety area as the weight of the transport object is heavier.

As the weight of the transport object increases, an inertial force also increases. Therefore, the collision avoidance device (2) adjusts the transport speed so that the heavy transport object can be more stably stopped in a case of emergency braking. In addition, in order to reduce the risk of collision caused by inertia, the safety area is widened so that the transport object can stop within a sufficient distance in a case of braking. This measure further improves the safety during a braking process, and minimizes the risk occurring to the worker and the surrounding environment during logistics transport.

The collision prevention device (2) according to one embodiment of the present disclosure may set the collision prevention safety area which is an area for preventing the collision of the transport object fastened to the gripping portion (100) while the transport object is transported in view of a probability of falling-down of the transport object.

While the transport object is moved while being fastened to the gripping portion (100), the probability of falling-down may occur depending on a change in the weight and the position of the transport object. Therefore, the collision prevention device (2) sets the safety area to prevent the risk in advance, and prevents a potential risk of collision on the movement path. When the worker or the obstacle is detected within the collision prevention safety area, the collision prevention device (2) immediately reduces the speed or temporarily stops to maintain a safe transport environment.

The collision prevention device (2) according to one embodiment of the present disclosure may widely set the collision prevention safety area as the probability of falling-down of the transport object fastened to the gripping portion (100) is higher.

When the shape or the fastening state of the transport object is unstable, the probability of falling-down becomes higher, and the risk of collision and safety accidents increases. Therefore, the collision prevention device (2) enlarges and sets the safety area to prevent the risk in advance. The widened collision prevention safety area enables the collision prevention device (2) to detect the risk when the worker or the obstacle approaches within a certain distance on the movement path of the transport robot (10). Accordingly, the collision prevention device (2) may immediately issue a warning or may take safety measures such as speed control or stopping the operation.

The collision prevention device (2) according to one embodiment of the present disclosure may analyze the probability of falling-down of the transport object fastened to the gripping portion (100) in view of various factors as follows to accurately analyze the probability of falling-down of the transport object fastened to the gripping portion (100), and thereafter, may widely set the collision prevention safety area as the probability of falling-down is higher. For example, the factors may correspond to a fastening method using a position of the center of gravity of the transport object and a negative pressure, a suction pressure distribution in the plurality of suction cups (320) installed in an n*n array along a bottom surface of the gripping portion (100), a suction leak degree of each suction cup (320), and a surface texture of the transport object.

These factors are comprehensively evaluated to determine whether the transport object is stably fastened, and when it is analyzed that the probability of falling-down is high, the collision prevention device (2) widely sets the collision prevention safety area to ensure a safer working environment. For example, when the center of gravity of the transport object is unstable or a suction leak occurs in a portion of the suction cup (320), the collision prevention device (2) automatically enlarges the surrounding safety area to reduce the risk of collision on the moving path.

Accordingly, the collision prevention safety control system according to one embodiment of the present disclosure having the above-described configuration monitors the probability of collision with the worker or the obstacle existing within the movement range of the transport robot (10) on a real-time basis by using the collision prevention device (2), and precisely controls the operation of the transport robot (10). When an unexpected obstacle or the worker is detected, the risk of collision is minimized through an immediate braking command or a path correction command, and the work is automatically resumed after the obstacle is removed. In this manner, the continuity of the logistics transport process may be maintained.

In addition, the movement path and the speed are adjusted in view of the weight and the volume of the transport object by using the collision prevention device (2), and distances from the worker and the obstacle are monitored on a real-time basis to analyze the probability of collision. When the risk is expected, the safety of the worker may be ensured, and damage to the transport object may be prevented by issuing a warning signal, controlling the speed, and temporarily stopping the operation.

In addition, through a 3D vision recognition function using a 3D vision camera, the shapes of not only the transport object but also the worker and the obstacle may be accurately recognized to predict the probability of collision and, when necessary, the path may be adjusted, or the operation may be temporarily stopped to prevent the risk of collision.

In addition, the impact occurring to the transport robot (10) or the transport object during the transport process is detected on a real-time basis, and a change in the fastening pressure of the gripping portion (100) is tracked to determine whether the collision occurs. When an abnormal pressure is detected by analyzing stability of the fastening state, the safety may be ensured by transmitting a warning signal and stopping the operation.

In addition, a change in the fastening state is detected on a real-time basis by using pressure information provided from a pressure monitoring sensor installed in the gripping portion (100), and when the fastening pressure is out of a set range, the collision prevention device (2) may immediately control the transport robot (10) to prevent the risk of collision.

In addition, the collision prevention device (2) prevents safety accidents that may occur due to an excessive speed by controlling the transport speed in accordance with various characteristics such as the weight of the transport object, and when the weight of the transport object is light, the collision prevention device (2) may improve efficiency by optimizing the transport speed.

In addition, in order to prevent the collision with the transport robot (10) or the transport object in an emergency situation, a proper collision prevention safety area may be set in accordance with the transport speed to prevent the collision in a case of braking.

The probability of falling-down of the transport object fastened to the gripping portion (100) is analyzed, and the collision prevention safety area is widened as the probability of falling-down is higher. In this manner, the safety of the worker and the surrounding environment is enhanced. In this case, stability may be improved in comprehensive view of factors such as the center of gravity, the suction pressure distribution, the suction leak degree, and the surface texture.

Accordingly, the collision prevention safety control system according to one embodiment of the present disclosure having the above-described configuration may significantly improve the safety and the efficiency of the logistics system by enhancing the work safety during the transport and loading process and by precisely controlling the operation in accordance with the characteristics of various transport objects. In this manner, the safety accidents may be prevented in logistics sites, a smooth progress of the transport work may be supported, and ultimately, reliability and productivity of a logistics operation may be maximized.

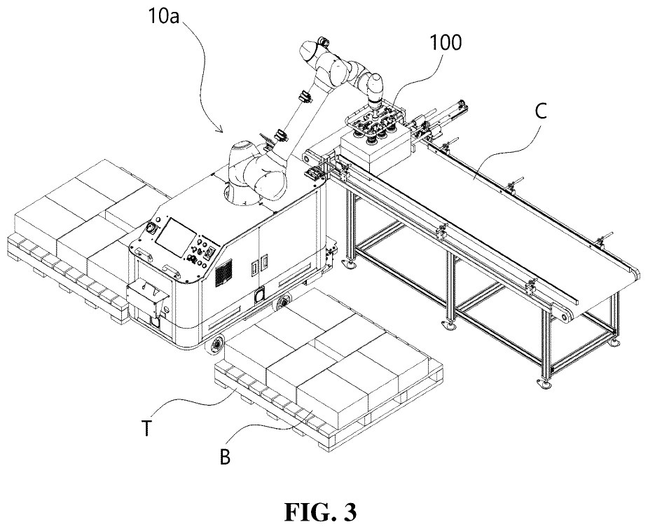

FIGS. 2 and 3 are diagrams showing a schematic configuration of the logistics transport and loading system according to one embodiment of the present disclosure.

Referring to FIGS. 2 and 3, the logistics transport and loading system according to one embodiment of the present disclosure includes at least one transport robot (10), a first identification camera (20), and a second identification camera (30).

In one embodiment, the transport robot (10) may include a plurality of robot arms (not shown), the gripping portion (100), and suction cups (320) to transport or load the transport object (B) to a specific location. The plurality of robot arms correspond to a collaborative robot or a multi-joint robot.

The transport object (B) serving as a transport target includes waste discharged from a medical site, for example, a box containing items contaminated with a patient's blood or body fluid in gloves, syringes, ampoules, gauze, or paper diapers, which may cause infection. Meanwhile, any item within a payload which can be transported by the transport robot (10) may correspond to the transport object.

The transport robot (10) may move the transport object (B) within a working radius of maximum 1,700 mm with a maximum payload of 25 kg, and may load or unload the transport object (B) up to a loading height of maximum 2.2 m.

When the worker brings a roll container (T) in which the transport object (B) is loaded to a work position, the first identification camera (20) performs 3D vision scanning on the transport object (B) loaded on the roll container (T), and transmits generated scanning data to the transport robot (10).

In one embodiment, the first identification camera (20) may identify the transport object (B) by using a 3D vision scanning method, and basically recognizes the transport object (B) loaded on an uppermost stage. Meanwhile, the first identification camera (20) may cumulatively identify the distribution of the transport object (B) stacked on each layer during the loading process of the transport object (B).

Although not shown in FIG. 2, the present disclosure may include the second identification camera (30) that performs 3D vision scanning on the transport object (B) loaded onto a conveyor (C) from the roll container (T) as in FIG. 3, and that transmits generated scanning data to the transport robot (10).

In the transport robots (10), a first transport robot (10a) transports and loads the transport object (B) loaded on the roll container (T) onto the conveyor (C) in accordance with a preset work order (for example, priority criteria or simple loading order) by using the scanning data received from each of the first identification camera (20) and the second identification camera (30).

In one embodiment, the first transport robot (10a) may detect a position and a shape of the transport object (B) loaded on the roll container (T) by using the scanning data received from the first identification camera (20).

In one embodiment, the first transport robot (10a) may sequentially transport and load the transport object (B) loaded on the roll container (T) onto the conveyor (C) in accordance with a preset work order (for example, the order of the transport object (B) loaded on a lower side from the transport object (B) loaded on an upper stage, or the order of the transport object (B) loaded on a right side from the transport object (B) loaded on a left side).

In one embodiment, the first transport robot (10a) may transport and load the transport object (B) loaded on the uppermost stage of the roll container (T) onto the conveyor (C) in the work order set based on a priority.

In one embodiment, the first transport robot (10a) may transport and load each layer of the transport objects (B) loaded in multiple layers on the roll container (T) onto the conveyor (C) in the work order set based on the priority (for example, the order of oldest discarded date).

In one embodiment, when the transport object (B) with a higher priority exists on a lower layer than the transport object (B) with a lower priority, the first transport robot (10a) may determine the work order again as follows. The first transport robot (10a) temporarily transports all or some of the transport objects (B) with the lower priority, which are located on the upper side of the layer where the transport object s (B) with the higher priority exist, to the conveyor (C), and thereafter, temporarily transports the transport object (B) to the roll container (T). The first transport robot (10a) rearranges the transport objects (B) loaded on the roll container (T) so that the transport object (B) with the higher priority is disposed on the upper layer.

In summary, when a precedent loading transport object which is the transport object to be loaded first in accordance with the set work order exists on the lower layer of a subsequent loading transport object which is the transport object to be loaded subsequently, the first transport robot (10a) may determine the work order again as follows. The first transport robot (10a) temporarily transports all or some of the subsequent loading transport objects located on on the upper side of the layer where the precedent loading transport objects exist, to the conveyor (C), and thereafter, temporarily transports the subsequent loading transport objects to the roll container (T), and thereafter, rearranges the transport objects (B) loaded on the roll container (T) so that the precedent loading transport objects are disposed on the upper layer. Meanwhile, when the transport objects (B) loaded on two or more roll containers (T) need to be arranged, the work order may be determined by temporarily transporting the transport object (B) between the roll containers (T) instead of the conveyor (C).

In one embodiment, when the transport object (B) need to be transported first to the conveyor (C) in accordance with the priority is found in the roll container (T), the first transport robot (10a) temporarily aligns the transport objects loaded first on the conveyor (C) in the conveyor (C), and thereafter, transports the transport object found in the roll container (T) to the conveyor (C). In this manner, the first transport robot (10a) may re-arrange the transport objects temporarily aligned on the conveyor (C).

The second transport robot (10b) loads and transports the transport object (B) moved by operating the conveyor (C) to another position.

The logistics transport and loading system according to one embodiment of the present disclosure may further include an incinerator conveyor (IC) for incinerating the transport object (B), and when the incinerator conveyor (IC) is included, the second transport robot (10b) loads and transports the transport object (B) moved to the conveyor (C) to the incinerator conveyor (IC).

With regard to the transport robot (10), the robot arm is the multi-joint robot having at least one joint, and moves the gripping portion (100) in various directions and at various angles.

The gripping portion (100) may include a suction portion (300) provided to suction the transport object (B) by using a vacuum. The suction portion (300) may be operated by a control module (not shown), and may suction various types of the transport objects (B) having a box shape by using the vacuum.

In other words, the gripping portion (100) may be installed in the other end of the transport robot (10), and may be fastened to the transport object (B) or may be separated from the fastened transport object (B).

Although not shown in FIGS. 2 and 3, the transport robot (10) may include sensors. Each of the sensors senses each object located within a certain distance from the transport robot (10), and transmits sensed sensing information to a control module that controls the operation of the transport robot (10). In one embodiment, the sensor is installed to prevent accidents caused by equipment in the vicinity while the transport robot (10) is operated. When the worker is closer to the sensor, the sensor may transmit a signal to the control module to temporarily stop the transport robot (10), and when the worker moves away again, the sensor may cut off the signal to restart the transport robot (10).

Hereinafter, the gripping portion (100) of the transport robot (10) will be described in detail.

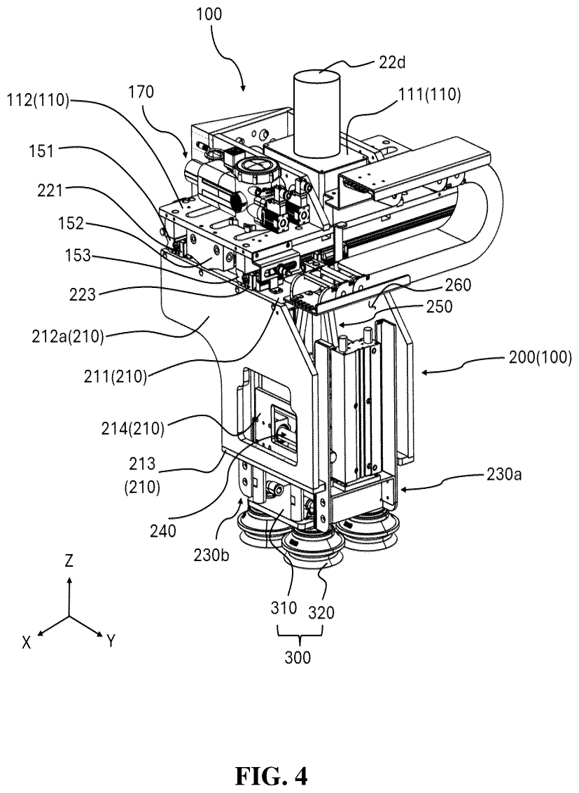

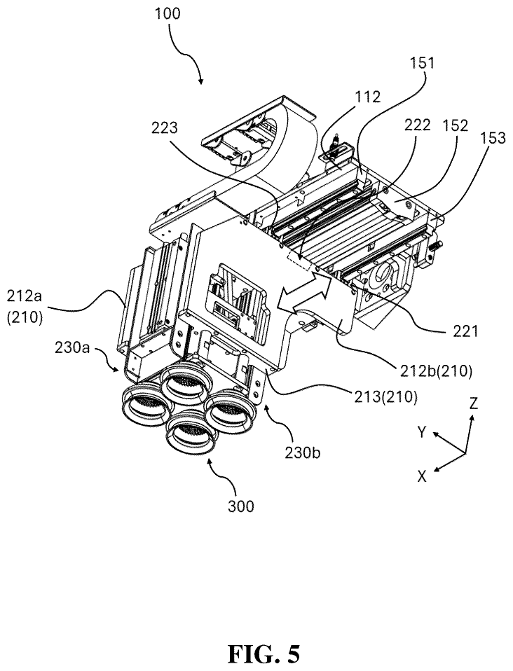

FIG. 4 is a perspective view showing the gripping portion connected to the robot arm according to one embodiment. FIG. 5 is a diagram shown at an angle different from an angle in FIG. 4.

Referring to FIGS. 4 and 5, the gripping portion (100) may include a fixing body (110) and a gripper assembly (200) connected to the fixing body (110).

The fixing body (110) may be coupled to the transport robot (10). In this manner, the gripping portion (100) may be e movable in response to the movement of the transport robot (10).

The fixing body (110) may include a first fixing body (111) directly coupled to the transport robot (10), and a second fixing body (112) coupled to the first fixing body (111) and connectable to the gripper assembly (200, described below) configured to grip the transport object (B).

As an example, the first fixing body (111) may have a substantially rectangular parallelepiped shape, and may be effectively coupled to the transport robot (10). Meanwhile, the shape of the first fixing body (111) is not limited to the above-described shape, and as a matter of course, the first fixing body (111) may be provided in various ways depending on requirements of each industrial site.

The second fixing body (112) may be disposed on a lower side (−Z side) of the first fixing body (111). For example, the first fixing body (111) may be mounted on an upper surface (surface facing +Z) of the second fixing body (112).

As an example, the second fixing body (112) may include a plate shape extending in a horizontal direction (+−X direction, +−Y direction), but the configuration is not limited thereto.

The gripping portion (100) may include rail portions (151, 152, and 153) mounted on the fixing body (110) and connected to the gripper assembly (200) to move the gripper assembly (200). For example, the rail portions (151, 152, and 153) may include a first rail portion (151), a second rail portion (152), and a third rail portion (153) which are mounted on the lower surface (surface facing −Z) of the second fixing body (112).

The first rail portion (151), the second rail portion (152), and the third rail portion (153) may be arranged to be separated from each other. The first rail portion (151), the second rail portion (152), and the third rail portion (153) may be installed on the lower surface of the second fixing body (112) to extend in a forward-backward direction (+−X direction). As will be described later, the gripper assembly (200) may be connected to each of the first rail portion (151), the second rail portion (152), and the third rail portion (153) to move in the forward-backward direction. As an example, the second rail portion (152) may be formed to be thicker than the first rail portion (151) and the third rail portion (153), but the configuration is not limited thereto.

The gripper assembly (200) may include a gripper body (210), slide portions (221, 222, and 223) coupled to the gripper body (210) and connected to the rail portion, a gripping module (230) provided to grip the transport object (B), a first hydraulic module (250) provided to move the gripping module (230), and a movement guide (240) that guides the movement of the gripping module (230).

The gripper body (210) may include an upper base (211) having an upper surface on which a first slide portion (221), a second slide portion (222), and a third slide portion (223) of the slide portions (221, 222, and 223) are respectively installed. The upper base (211) may be disposed to face the second fixing body (112). As an example, the shape of the upper base (211) may include a plate shape extending in the horizontal direction, but the configuration is not limited thereto.

The first slide portion (221) may be installed at a position corresponding to the first rail portion (151) on the upper surface of the upper base (211). The first slide portion (221) may be slidably coupled to the first rail portion (151). The first slide portion (221) may be coupled to the first rail portion (151) to slide in the forward-rearward direction.

The second slide portion (222) may be installed at a position corresponding to the second rail portion (152) on the upper surface of the upper base (211). The second slide portion (222) may be slidably coupled to the second rail portion (152). The second slide portion (222) may be coupled to the second rail portion (152) to slide in the forward-rearward direction.

The third slide portion (223) may be installed at a position corresponding to the third rail portion (153) on the upper surface of the upper base (211). The third slide portion (223) may be slidably coupled to the third rail portion (153). The third slide portion (223) may be coupled to the third rail portion (153) to slide in the forward-rearward direction. In this manner, the upper base (211) may slide in the forward-rearward direction.

The gripper body (210) may include a first side wall (212a) and a second side wall (212b) which are respectively installed in both ends of the upper base (211) in the forward-rearward direction and extend downward. The first side wall (212a) and the second side wall (212b) may each include openings, and may be disposed to be separated from each other in the forward-rearward direction.

The first hydraulic module (250), the gripping module (230), and the movement guide (240) may be located in a space formed by separation between the first side wall (212a) and the second side wall (212b). In this manner, the first hydraulic module (250), the gripping module (230), and the movement guide (240) may be protected from the outside by the first side wall (212a) and the second side wall (212b).

The gripper body (210) may include a lower base (213) coupled to each end of the lower side of the first side wall (212a) and the second side wall (212b) and extending in the horizontal direction. The lower base (213) may extend in a direction parallel to the upper base (211).

As an example, the upper base (211), the first side wall (212a), the second side wall (212b), and the lower base (213) may form an accommodation groove (260). In other words, the accommodation groove (260) may be a space surrounded by the upper base (211), the first side wall (212a), the second side wall (212b), and the lower base (213).

The first hydraulic module (250), the gripping module (230), and the movement guide (240) may be accommodated in the accommodation groove (260). More specifically, the gripping module (230) may grip the transport object (B). When the gripping module (230) does not grip the transport object (B), the gripping module (230) may be accommodated in the accommodation groove (260). Details thereof will be described later.

The suction portion (300) may fasten the transport object (B) by using the vacuum. As an example, the suction portion (300) may be installed on the lower surface of the lower base (213), and may extend downward.

More specifically, the suction portion (300) may include a suction body (310) coupled to the lower base (213) of the gripper body (210), and the suction cup (320) installed in the suction body (310) and provided to come into contact with the transport object (B).

As an example, the suction body (310) may have a plate shape extending in a direction corresponding to an extending direction of the lower base (213), but the configuration is not limited thereto.

The suction cup (320) may be installed on the lower surface of the suction body (310), and may suction the transport object (B) by using vacuum. The gripping portion (100) may include a vacuum module (170) installed in the fixing body (110).

As an example, the vacuum module (170) may include a configuration operable so that air is drawn and discharged to form a vacuum state.

The vacuum module (170) may be connected to the suction cup (320). Accordingly, when the vacuum module (170) is operated, the air inside the suction cup (320) may flow to the vacuum module (170) to form the vacuum state inside the suction cup (320). Thereafter, the gripping portion (100) may be moved to the upper side of the transport object (B) by the transport robot (10), and the suction portion (300) may come into contact with the upper surface of the transport object (B) to suction the transport object (B). In this manner, the transport object (B) may be stably fixed to the gripping portion (100) by an operation of the suction portion (300).

The gripper body (210) may include a pair of connecting bases (214) installed on the upper surface of the lower base (213) and extending upward. The connecting bases (214) may be separated from each other.

The pair of connecting bases (214) may be respectively installed on one end side of the lower base (213) in the forward-rearward direction. A space formed by separation between the pair of connecting bases (214) may be a smaller space than the space of the accommodation groove (260). An extending length of each of the pair of connecting bases may be shorter than an extending length of the first side wall (212a) or the second side wall (212b) in an upward-downward direction, but the configuration is not limited thereto.

The gripping module (230) may grip the transport object (B). The first hydraulic module (250) may be operable to move the gripping module (230) in a direction parallel to a first direction.

As an example, the first direction may mean a rightward-leftward direction (+−Y direction), but the configuration is not limited thereto. The gripping module (230) may be connected to the first hydraulic module (250).

The gripping module (230) may include a first gripping module (230a) disposed on one side of the fixing body (110) and a second gripping module (230b) installed on a side opposite to the first gripping module (230a) with reference to the first hydraulic pump (251). That is, the gripping module (230) may include a pair of the gripping modules (230a and 230b). The pair of the gripping modules (230a and 230b) may be separated from each other. The pair of the gripping modules (230a and 230b) may dispose the transport object (B) in a space separated from each other, and may move toward each other to grip the transport object (B). Details thereof will be described later.

The first hydraulic module (250) may be operated to pressurize the pair of gripping modules (230a and 230b) accommodated in the accommodation groove (260) in an outward direction of the accommodation groove (260). The first hydraulic module (250) may be connected to each of the pair of gripping modules (230a and 230b).

The first hydraulic module (250) may be installed on the lower base (213). The first hydraulic module (250) may be disposed between the pair of connecting bases (214).

The first hydraulic module (250) may be operated to pressurize the pair of gripping modules (230a and 230b) located outside the accommodation groove (260) in a direction facing the accommodation groove (260). The first hydraulic module (250) will be described later.

The movement guide (240) may guide the movement of the gripping module (230) that moves in response to an operation of the first hydraulic module (250). The movement guide (240) may be connected to the gripping module (230). The movement guide (240) may be accommodated in the accommodation groove (260).

The movement guide (240) may be installed on an inner surface of the connecting base (214). As an example, the inner surface of the connecting base (214) may mean a surface of the connecting base (214) which faces the first hydraulic module (250). The movement guide (240) will be described in detail later.

Referring to the above-described configuration, the upper base (211) may be slidably connected to the second fixing body (112). In addition, the first side wall (212a) and the second side wall (212b) are coupled to the upper base (211), and the lower base (213) is coupled to the first side wall (212a) and the second side wall (212b). In addition, the first hydraulic module (250) and the connecting base (214) may be coupled to the lower base (213), and the movement guide (240) may be coupled to the connecting base (214). In addition, the gripping module (230) may be connected to the first hydraulic module (250) and the movement guide (240).

In conclusion, the gripper assembly (200) may be slidably connected to the second fixing body (112), and may slide along the forward-rearward direction in which the second fixing body (112) extends. As an example, the control module may control the movement of the gripper assembly by controlling the first slide portion (221), the second slide portion (222), and the third slide portion (223). In this manner, the gripper assembly (200) may be moved to a position where the gripper assembly (200) effectively grip the transport object (B).

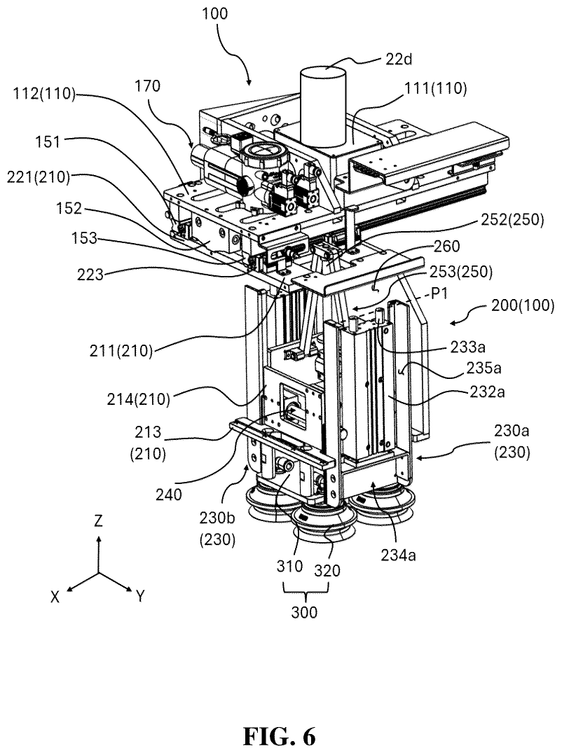

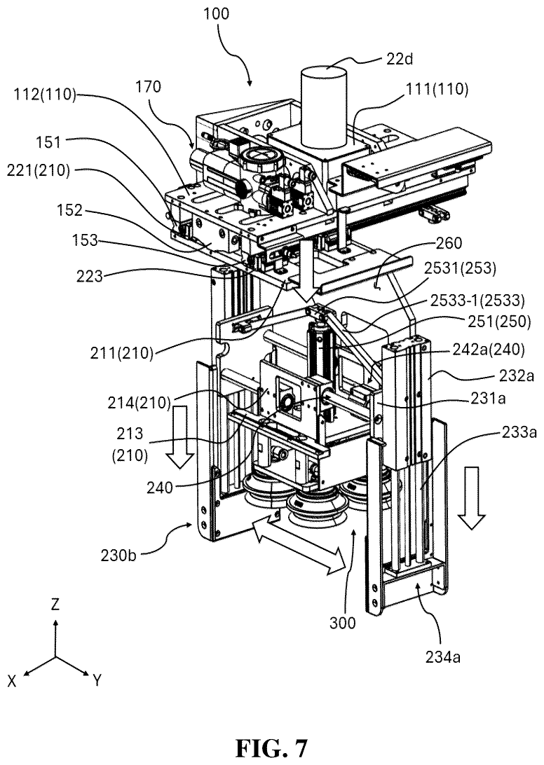

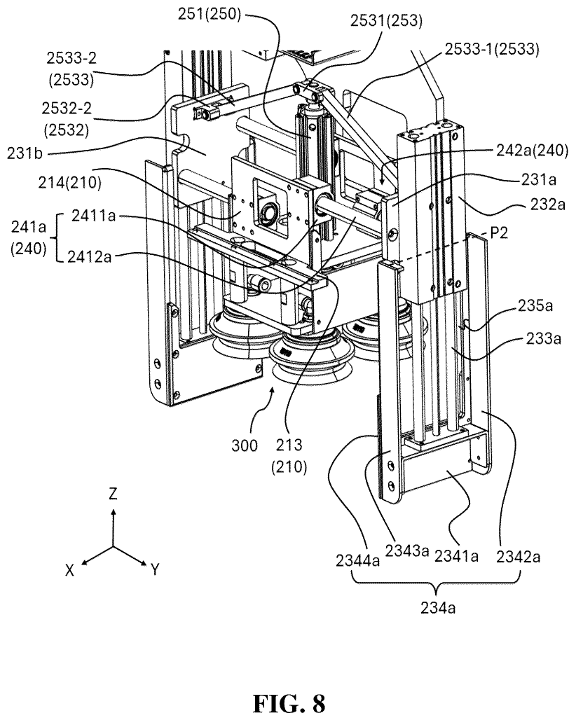

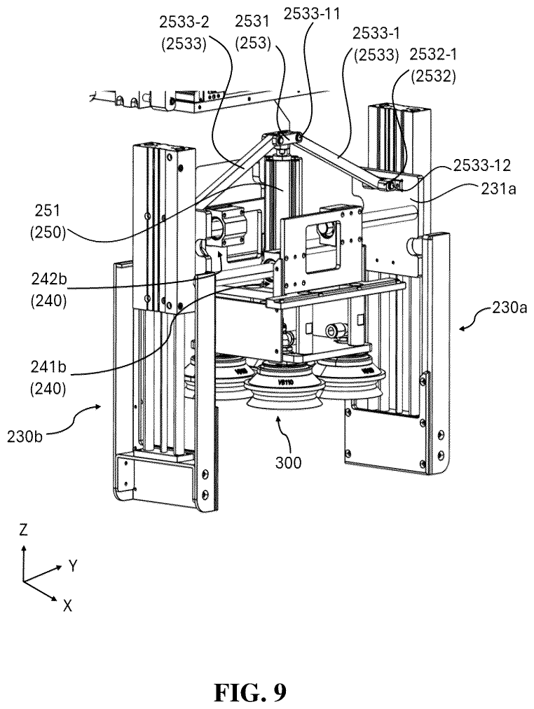

FIG. 6 is a diagram in which some of components of a detachment assembly in FIG. 4 are omitted to show internal components of the detachment assembly in more detail. FIG. 7 is a diagram showing a state where the gripping module moves in response to an operation of the first hydraulic module in the detachment assembly in FIG. 6. FIG. 8 is a partially enlarged view of a portion in FIG. 7. FIG. 9 is a diagram shown at an angle different from an angle in FIG. 8. Hereinafter, repeated description of the above-described contents will be omitted.

Referring to FIGS. 6 to 8, the first hydraulic module (250) may be connected to the pair of the gripping modules (230a and 230b). Before the first hydraulic module (250) moves the pair of the gripping modules (230a and 230b), the pair of the gripping modules (230a and 230b) may be accommodated in the accommodation groove (260). That is, the gripping modules (230) may be accommodated in the accommodation groove (260) when not in use. Accordingly, interference with other loaded transport objects (B) may be minimized when the gripping portion (100) moves.

The first hydraulic module (250) may be connected to each of the pair of the gripping modules (230a and 230b), and may move the pair of the gripping modules (230a and 230b) outward from the accommodation groove (260). As an example, the first hydraulic module (250) may be operated to move the pair of the gripping modules (230a and 230b) in a direction parallel to the first direction. As an example, the direction parallel to the first direction may mean the forward-rearward direction (+−Y direction), but the configuration is not limited thereto.

Hereinafter, for the convenience of description, the description of the first hydraulic module (250) will be continued based on the first gripping module (230a) which is one of the pair of gripping modules (230a and 230b). As a matter of course, the description based on the first gripping module (230a) may be applicable to the second gripping module (230b) within the applicable scope. In addition, for the convenience of description, the first gripping module (230a) will be referred to and described as ‘the gripping module’. In addition, when the first gripping module (230a) and the second gripping module (230b) need to be distinguished from each other, the first gripping module (230a) and the second gripping module (230b) will be separately described.

The first hydraulic module (250) may include a first hydraulic pump (251) installed on the lower base (213), a first hydraulic shaft (252) connected to the first hydraulic pump (251) and configured to move in a direction parallel to a second direction intersecting the first direction, and a crank (253) connecting the first hydraulic shaft (252) and the gripping module (230a) to transmit the movement to the gripping module (230a) by converting the movement of the first hydraulic shaft (252) in the direction parallel to the second direction into the movement in the direction parallel to the first direction.

The first hydraulic pump (251) may include a cylinder shape extending in the upward-downward direction. The first hydraulic shaft (252) may be inserted into the first hydraulic pump (251) to move in a direction parallel to the second direction. As an example, the direction parallel to the second direction may mean the upward-downward direction, but the configuration is not limited thereto.

As an example, one end of the first hydraulic shaft (252) may be located outside the first hydraulic pump (251), and the other end of the first hydraulic shaft (252) may be inserted into the first hydraulic pump (251).

The first hydraulic pump (251) may be disposed between the pair of connecting bases (214). The first hydraulic shaft (252) may be disposed between the pair of connecting bases (214).

The gripping module (230a) may include a connecting member (231a) connected to a crank (253) and disposed to face the accommodation groove (260). The connecting member (231a) may have a substantially plate shape, but the configuration is not limited thereto.

The crank (253) may include a first hinge (2531) coupled to one end of the first hydraulic shaft (252) located outside of the first hydraulic pump (251), a second hinge (2532) coupled to the connecting member (231a) of each of the first gripping module (230a) and the second gripping module (230b), and a crank body (2533) connecting the first hinge (2531) and the second hinge (2532).

As an example, the crank body (2533) may have a rod shape extending in one direction, but the configuration is not limited thereto.

The first hinge (2531) may move along the movement of the first hydraulic shaft (252) in the direction parallel to the second direction. That is, the first hinge (2531) may move in the direction parallel to the second direction.

One end of the crank body (2533) may be connected to the first hinge (2531). In other words, one end of the crank body (2533) may move in the direction parallel to the second direction.

As will be described later, the movement direction of the connecting member (231a) of the gripping module (230a) may be limited to the direction parallel to the first direction by the movement guide (240). Accordingly, a second hinge (2532-1) coupled to the connecting member (231a) may move in the direction parallel to the second direction. In conclusion, the other end of the crank body (2533-1) connected to the second hinge (2532-1) may move in the direction parallel to the second direction.

The crank body (2533) may rotate with reference to on one end of the crank body (2533-1) connected to the first hinge (2531) and the other end of the crank body (2533-1) connected to the second hinge (2532). In other words, the crank body (2533-1) may rotate with reference to on one end of the crank body (2533-1), and may rotate with reference to the other end of the crank body (2533-1).

In this manner, the crank body (2533-1) may perform both a rotational motion and a translational motion, and the motions may be transmitted to the connecting member (231a) while converting a motion of the first hydraulic shaft (252) moving in the direction parallel to the second direction into a motion in the direction parallel to the first direction.

The second gripping module (230b) which is the other one of the pair of gripping modules (230a and 230b) may be disposed on a side opposite to the first gripping module (230a) with reference to the first hydraulic module (250).

As an example, the second hinge (2532) may include a 2-1 hinge (2532-1) coupled to the first gripping module (230a) and a 2-2 hinge (2532-2) coupled to the second gripping module (230b). In addition, the crank body (2533) may include a first crank body (2533-1) connecting the first hinge (2531) and the second-first hinge (2532-1), and a second crank body (2533-2) connecting the first hinge (2531) and the second-second hinge (2532-2).

When the first hydraulic shaft (252) moves in the direction parallel to the second direction, the first crank body (2533-1) may rotate with reference to one end (2533-11) of the first crank body connected to the first hinge (2531) and the other end (2533-12) of the first crank body connected to the 2-1 hinge (2532-1). In this manner, the first crank body (2533-1) may convert the movement of the first hydraulic shaft (252) in the direction parallel to the second direction into the movement of the first gripping module (230a) in the direction parallel to the first direction.

When the first hydraulic shaft (252) moves in the direction parallel to the second direction, the second crank body (2533-2) may rotate with reference to one end of the second crank body (2533-2) connected to the first hinge (2531) and the other end of the second crank body (2533-2) connected to the 2-2 hinge (2532-2). In this manner, the second crank body (2533-2) may convert the movement of the first hydraulic shaft (252) in the direction parallel to the second direction into the movement of the second gripping module (230b) in the direction parallel to the first direction.

As an example, the 2-1 hinge (2532-1) may be coupled to the connecting member (231a) of the first gripping module (230a). As an example, the 2-2 hinge (2532-2) may be coupled to the connecting member (231a) of the second gripping module (230b).

As an example, the movement directions of the first gripping module (230a) and the second gripping module (230b) may be opposite to each other. As an example, when the first gripping module (230a) is moved in the first direction by the first hydraulic module (250), the second gripping module (230b) may be moved in the direction opposite to the first direction by the operation of the first hydraulic module (250).

As an example, the movement guide (240) may include a plurality of movement guides (241a, 242a, 241b, and 242b).

As an example, the first gripping module (230a) may be connected to two movement guides (241a and 242a), and the second gripping module (230b) may be connected to two movement guides (241b and 242b), but the configuration is not limited thereto.

The two movement guides (241a and 242a) connected to the first gripping module (230a) may be disposed to be separated from each other in the second direction, and may be disposed to be separated from each other in a third direction which is a direction intersecting each of the first direction and the second direction.

Hereinafter, the movement guide (240) will be described with reference to one movement guide (241a) of the two movement guides (241a and 242a) connected to the first gripping module (230a). As a matter of course, the description of the movement guide (240) described below may be equally applicable to each of the movement guides (241a, 242a, 241b, and 242b) connected to the first gripping module (230a) and the second gripping module (230b). Hereinafter, the first gripping module (230a) will be referred to as the ‘gripping module (230a)’.

The movement guide (241a) may include a guide bar (2412a) connected to one surface of the connecting member (231a) of the gripping module (230), and a guide socket (2411a) fixed to the connecting base (214) and disposed so that the guide bar (2412a) can pass therethrough.

The guide bar (2412a) may be disposed to extend in the direction parallel to the first direction. As an example, the guide bar (2412a) may have a rod shape extending in the direction parallel to the first direction, but the configuration is not limited thereto.

As an example, the guide socket (2411a) may be fixed to an inner surface of the connecting base (214). The guide socket (2411a) may have a hollow cylindrical shape including a through hole, and the guide bar (2412a) may be inserted into the through hole. The guide bar (2412a) may be movable by penetrating the guide socket (2411a).

As an example, the through hole of the guide socket (2411a) may extend in the direction parallel to the first direction. Accordingly, the guide bar (2412a) may be inserted into the through hole to slide in the direction parallel to the first direction.

One end of the guide bar (2412a) may be connected to the connecting member (231a) of the gripping module (230a). As an example, one end of the guide bar (2412a) may be connected to one surface of the connecting member (231a) facing the accommodation groove (260). As an example, one end of the guide bar (2412a) may be connected to one surface of the connecting member (231a) in which the second hinge (2532) is installed, but the configuration is not limited thereto. As an example, the guide bar (2412a) may be vertically connected to the connecting member (231a).

The through hole of the guide socket (2411a) may extend in the direction parallel to the first direction, and the guide bar (2412a) may slide in the direction parallel to the first direction. Therefore, the connecting member (231a) connected to the guide bar (2412a) may move in the direction parallel to the first direction. Accordingly, the connecting member (231a) may be moved in the direction parallel to the first direction by the operation of the first hydraulic module (250). In this manner, the gripping module (230a) may move in the direction parallel to the first direction.

As an example, the guide socket (2411a) may be installed in the connecting base (214a) to be disposed at a position closer to the gripping module (230a) than the first hydraulic module (250a).

As described above, the first gripping module (230a) may be connected to each of the movement guides (241a and 242a) which are separated from each other in the second direction and the third direction. In addition, the second gripping module (230b) may be connected to each of the movement guides (241b and 242b) which are separated from each other in the second direction and the third direction.

As an example, in the mutually different movement guides (241a and 241b) connected to one of the pair of the connecting bases (214), the movement guide (240) connected to the first gripping module (230a) and the movement guides (241a and 241b) connected to the second gripping module (230b) may be disposed to be separated from each other in the direction parallel to the first direction and the second direction.

Hereinafter, for the convenience of description, the gripping module (230) will be described with reference to the first gripping module (230a). Hereinafter, for the convenience of description, the first gripping module (230a) will be referred to as the gripping module (230a) within the necessary scope. In addition, as a matter of course, the following description regarding the first gripping module (230a) may be equally applicable to the second gripping module (230b) within the corresponding scope.

The gripping module (230a) may include a connecting member (231a) including one surface coupled to the crank (253), a second hydraulic pump (232a) installed on the other surface of the connecting member (231a), a second hydraulic shaft (233a) connected to the second hydraulic pump (232a) and movable in the direction parallel to the second direction, and a gripping member (234a) connected to a lower side of the second hydraulic shaft (233a), movable in the direction parallel to the second direction, and capable of gripping the transport object (B) by coming into contact with the transport object (B).

As described above, the connecting member (231a) may have a plate shape vertically coupled to the guide bar (2412a) of the movement guide (241a).

The second hydraulic pump (232a) may be formed to extend in the direction parallel to the second direction. The second hydraulic pump (232a) may be installed on one surface of the connecting member (231a) facing a side opposite to the accommodation groove (260).

The second hydraulic shaft (233a) may be mounted on the second hydraulic pump (232a). The second hydraulic shaft (233a) may be moved in the direction parallel to the second direction by the operation of the second hydraulic pump (232a).

The gripping member (234a) may include a first member body (2341a) coupled to a lower end of the second hydraulic shaft (233a) and extending in the direction parallel to the third direction, a pair of second member bodies (2342a and 2343a) respectively extending in the direction parallel to the second direction from both ends of the first member body (2341a) in the direction parallel to the third direction, and a third member body (2344a) coupled to one surface of each of the pair of second member bodies (2342a and 2343a) facing the first hydraulic pump (251). As an example, the third direction may mean the forward-rearward direction (+−X direction), but the configuration is not limited thereto.

The first absence body (2341a) may be formed to extend in the direction parallel to the third direction.

The pair of second member bodies (2342a, 2343a) may be disposed to be separated from each other in the third direction. The pair of second member bodies (2342a, 2343a) may be installed in each of both ends of the first member body (2341a). A space formed by separation between the pair of second member bodies (2342a, 2343a) may be referred to as a separation space (235a). As an example, the first member body (2341a) may form a lower end portion of the separation space (235a).

The second hydraulic pump (232a) and the second hydraulic shaft (233a) may be accommodated in the separation space (235a). In this manner, the second hydraulic pump (232a) and the second hydraulic shaft (233a) may be protected from external interference by the pair of second member bodies (2342a and 2343a).

The third member body (2344a) may be installed to be in contact with each surface of the pair of second member bodies (2342a and 2343a) facing the first hydraulic pump (251). In other words, the third member body (2344a) may be installed on each surface of the pair of second member bodies (2342a and 2343a) facing the accommodation groove (260). In addition, the third member body (2344a) may be coupled to the first member body (2341a) to be in contact with one surface of the first member body (2341a) facing the accommodation groove (260). Since the plurality of configurations and the third member body (2344a) are respectively coupled, installation rigidity of the third member body (2344a) can be increased.

As an example, one surface of the third member body (2344a) disposed to face the accommodation groove (260) may come into contact with the transport object (B). As an example, one surface of the third member body (2344a) facing the accommodation groove (260) may have various materials and shapes to increase a frictional force with the transport object (B).

As described above, the first member body (2341a) is connected to the second hydraulic shaft (233a) which is movable in the direction parallel to the second direction. Therefore, the third member body (2344a) connected to the first member body (2341a) is movable in the direction parallel to the second direction.

As an example, the third member body (2344a) may be movable to be located below the suction portion (300). As an example, the third member body (2344a) may be movable to be located above the suction portion (300).

More specifically, the gripping member (234a) may be movable between a first position (P1, refer to FIG. 6) located to accommodate the second hydraulic pump (232a) in a space formed by separation between the pair of second member bodies (2342a, 2343a), and a second position (P2, refer to FIG. 8) located to accommodate a portion of the second hydraulic pump (232a) in the separation space (235a).

As an example, when the gripping member (234a) is located at the first position (P1), the third member body (2344a) may be located above the suction portion (300). That is, when the gripping module (230) does not grip the transport object (B), the gripping member (234a) may be located at the first position (P1). As an example, when the gripping member (234a) is located at the second position (P2), the third gripping member (234a) may be located below the suction portion (300). Since the suction cup (320) of the suction portion (300) is provided to come into contact with the upper surface of the transport object (B), the third gripping member (234a) may move further downward to come into contact with the side surface of the transport object (B).

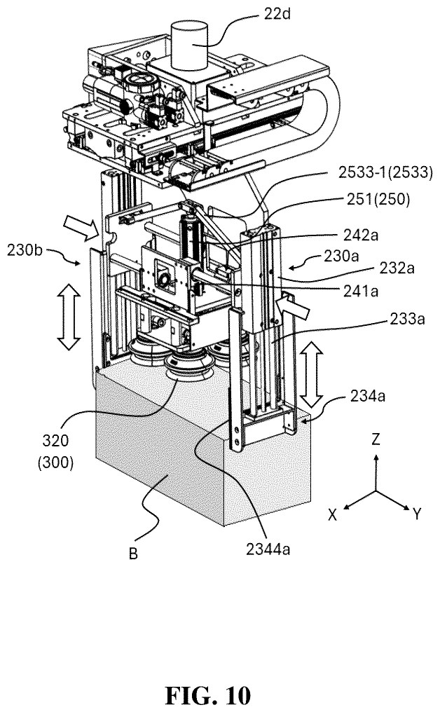

FIG. 10 is a diagram showing a state where a transport device according to one embodiment of the present invention grips and suctions an object. Hereinafter, a process in which the detachment assembly transports an object will be described in detail. Repeated description of the contents will be omitted below.

Referring to FIG. 10, the control module may control transport units (21 and 22) so that the transport units (21 and 22) transport the gripping portion (100) to a position adjacent to the transport object (B). As an example, in a state where the gripping module (230) is in a standby state where the gripping module (230) does not grip the transport object (B), the gripping member (234a) may be located at the first position (P1), and the gripping module (230) may be in an accommodated state in the accommodation groove (260).

After the gripping portion (100) is moved to a position adjacent to the transport object (B), the control module may control the first hydraulic pump (251) to lower the first hydraulic shaft (252). In this manner, the crank (253) may pressurize the first gripping module (230a) and the second gripping module (230b) to move outward from the accommodation groove (260). That is, in an operating state of the gripping module (230) to grip the transport object (B), the first hydraulic module (250) may be operated to move the gripping module (230) in the direction parallel to the first direction facing outward from the accommodation groove (260). In this case, a separated distance between the first gripping module (230a) and the second gripping module (230b) may be longer than the length of the transport object (B) in the horizontal direction.

Thereafter, the control module may control the transport units (21 and 22) so that the suction cup (320) of the suction portion (300) comes into contact with the upper surface of the transport object (B). When the suction cup (320) and the upper surface of the transport object (B) are in contact with each other, the control module may operate the vacuum module (170) to form a vacuum state in an internal space of the suction cup (320). In this manner, the suction portion (300) may fix the transport object (B) by suctioning the transport object (B).

Thereafter, the control module may operate the second hydraulic modules (232a and 233a) so that the gripping member (234a) is located at the second position (P2). In this manner, the third gripping member (234a) of the second hydraulic modules (232a and 233a) may be located at a distance vertically corresponding to the side surface of the transport object (B).

The control module may control the operation of the first hydraulic module (250) so that the first hydraulic shaft (252) moves upward. In this manner, the first gripping module (230a) and the second gripping module (230b) may move in the direction facing the accommodation groove (260), and the third gripping member (234a) may grip the transport object (B) by coming into contact with the side surface of the transport object (B).

Thereafter, the control module may control the transport units (21 and 22) so that the transport object (B) moves to a position corresponding to an instruction of the worker (W). As an example, the corresponding position may be a conveyor (23, refer to FIG. 3) that transports the transport object (B) to another location.

After the transport object (B) moves to the position corresponding to the instruction of the worker (W), the control module may stop the operation of the vacuum module (170). In this manner, the vacuum state inside the suction cup (320) may be released, and the suction between the suction cup (320) and the transport object (B) may be stopped so that the transport object (B) is separated from the suction portion (300).

The control module may operate the first hydraulic pump (251) to move the first hydraulic shaft (252) downward. In this case, the first gripping module (230a) and the second gripping module (230b) may move in a direction opposite to the accommodation groove (260), and the contact between the third gripping member (234a) and the side surface of the transport object (B) may be released. Accordingly, the transport object (B) may be separated from the gripping portion (100).

After the transport object (B) is completely separated from the gripping portion (100), the control module may operate the second hydraulic pump (232a), and may move the second hydraulic shaft (233a) upward so that the gripping member (234a) returns to the first position (P1). The control module may operate the first hydraulic pump (251), and may move the first hydraulic shaft (252) upward so that the first gripping module (230a) and the second gripping module (230b) move to the accommodation groove (260).

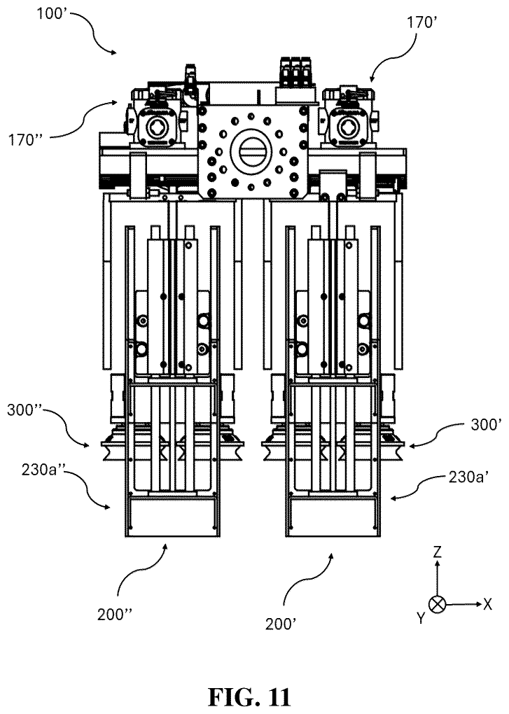

FIG. 11 is a diagram showing a transport device according to one embodiment. Repeated description of the contents will be omitted below.

Referring to FIG. 11, a gripping portion (100′) may include a first gripper assembly (200′) and a second gripper assembly (200″) disposed parallel to the first gripper assembly (200′). Each of the first gripper assembly (200′) and the second gripper assembly (200″) may be coupled to the second fixing body (112). Since a plurality of the gripper assemblies (200′ and 200″) may be provided, the gripping portion (100′) may more stably suction, grip, and transport the transport object (B).

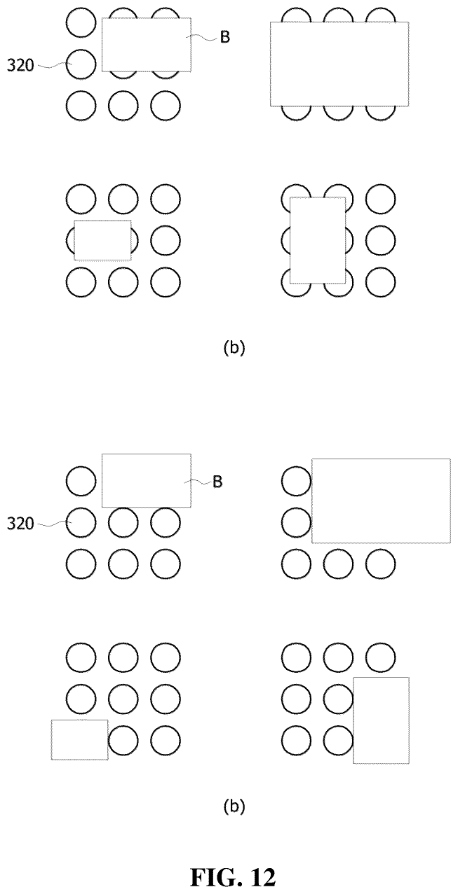

Hereinafter, tilting of the gripping portion (100) will be described with reference to FIGS. 12 to 14.

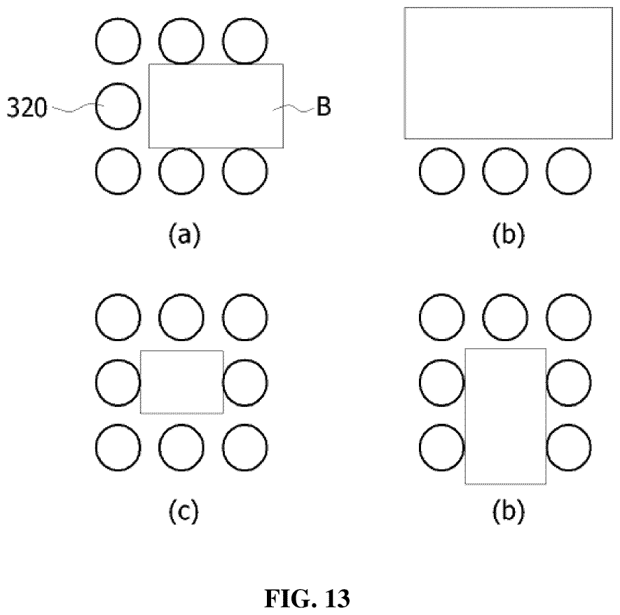

FIG. 12 is a diagram showing examples in which the object is incorrectly fastened by the suction cup of the gripping portion, and FIG. 13 is a diagram showing examples in which the object is correctly fastened by the suction cup of the gripping portion.

The gripping portion (100) is moved by the robot arm, and the suction cups (320) are installed in an n*n row along a bottom surface as shown in FIGS. 12 and 13.

The suction cups (320) are installed in the n*n row along the bottom surface of the gripping portion (100), and fasten the transport object (B) by using a negative pressure.

Here, an angle and a movement degree of the suction cup (320) need to be adjusted by the gripping portion (100) so that only the suction cup capable of suctioning the transport object (B) without exceeding an area of the transport object (B) as shown in FIG. 13 is fastened to the transport object (B).

In one embodiment, the robot arm may move the gripping portion (100) so that the number of the suction cups (320) which are completely seated without being partially detached from the upper surface of the transport object (B) (in cases of (a), (b), and (c) in FIG. 12) is maximized, and the center of gravity of the transport object (B) is brought close to the center of the gripping portion (100) (in cases of (a), (b), (c), and (d) in FIG. 13).

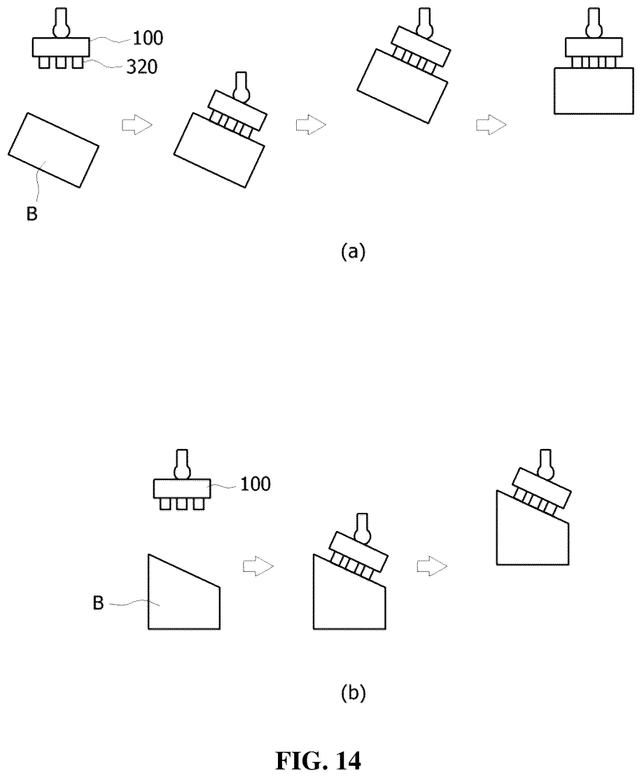

FIG. 14 is a diagram showing examples of methods for fastening the transport object by using the transport robot.

In one embodiment, the robot arm reads the tilting of the transport object (B) as a transport target loaded on the roll container (T) by using the scanning data received from the first identification camera (20) (in a case of (a) of FIG. 20), tilts the gripping portion (100) at the same tilting angle as the tilting angle of the upper surface of the tilted transport object (B), and thereafter, causes the gripping portion (100) to be seated on the transport object (B). After the transport object (B) is fastened, the tilting of the gripping portion (100) is released during the transport process so that the transport object (B) is transported at a normal angle.

In one embodiment, when it is read that a shape of the transport object (B) as a transport target is other than a hexahedron (in the case of (b) of FIG. 6) by using the scanning data received from the first identification camera (20), the robot arm tilts the gripping portion (100) at the same tilting angle as the tilting angle of the upper surface of the transport object (B) having a tilting surface, and thereafter, causes the gripping portion (100) to be seated on the transport object (B). The robot arm releases a fixing state of the gripping portion (100) before the fixing of the suction cup (320). Thereafter, when the transport object (B) is lifted after the fixing of the suction cup (320), the robot arm fixes the tilting of the gripping portion (100) again. In this manner, misalignment of the items contained in the transport object (B) may be prevented.

In one embodiment, in a database form, the robot arm stores a suction limit of the suction cup (320) depending on a weight of the transport object (B) for each tilting angle of the gripping portion (100) (for example, 100 kg for horizontal suction, 50 kg for 30-degree oblique suction, or the like), and may transport the transport objects (B) as the transport targets loaded on the roll container (T) only when the transport object (B) is transportable after identifying each weight distribution of the transport objects (B).

Depending on the weight distribution inside the transport object (B) or a shape or a suction position of the transport object (B), the transport object (B) may tilt due to the center of gravity of the transport object (B) during a lifting process.

For this reason, in order to prevent the tilting of the transport object (B), the transport robot (10) may additionally include a balance device (not shown in the drawing for convenience of description) that fixes the tilting angle after suctioning.

The logistics transport and loading system according to one embodiment of the present disclosure having the above-described configuration may detect the position and the shape of the transport object loaded on the roll container by using the transport robot and the 3D vision system, and thereafter, may automatically transport and load the transport object onto the conveyor. In this manner, the logistics transport and loading system may contribute to a safe and hygienic process, and improved safety and efficiency when the transport object is transported and loaded onto the conveyor.

In addition, the safety of the workers may be ensured, and the logistics may be efficiently managed.

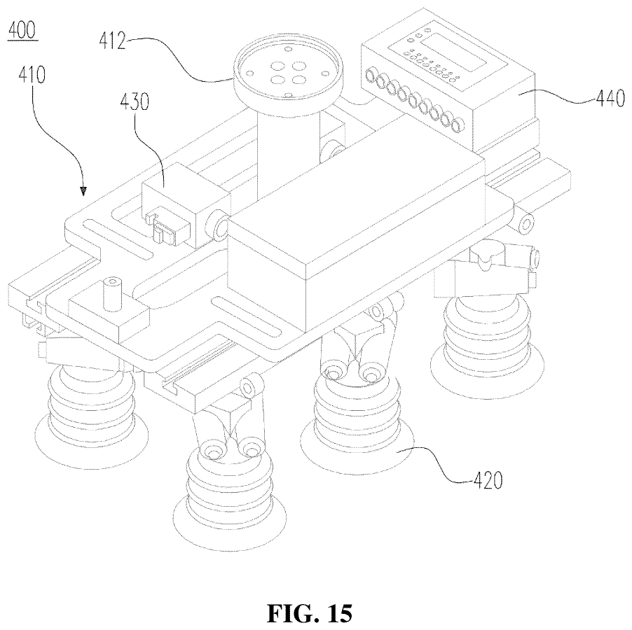

FIG. 15 is a diagram showing a suction gripper in the related art.

Referring to FIG. 15, a suction gripper (400) in the related art includes a gripper body (410), multiple suction units (420), an air control valve (430), and an air pressure switch (440).

The gripper body (410) is installed in an end portion of a collaborative robot, and configurations such as the multiple suction units (420), the air control valve (430), and the air pressure switch (440) are installed therein.

In one embodiment, at least one guide bar for preventing collision with other objects along the periphery is installed in the gripper body (410).

The suction unit (420) is formed in a suction cup shape, and multiple suction units (preferably six units) are provided. The suction unit (420) is installed along a lower side of the gripper body (410), and uses the vacuum formed by the air control valve (430) to fasten the object in a tightly suctioned state.

The air control valve (430) suctions air from the suction unit (420) to form the vacuum.

The air pressure switch (440) senses a level of the negative pressure formed in the suction unit (420), and controls the operation of the air control valve (430).

The above-described embodiments are provided as examples, and those skilled in the art may understand that the above-described embodiments can be easily modified into other specific forms without changing the technical idea or the essential features of the above-described embodiments. Therefore, the above-described embodiments should be understood as illustrative and not restrictive in all respects. For example, respective component described as a single entity may be implemented in a distributed manner, and likewise, components described in the distributed manner may be implemented in a combined manner.

The scope to be protected by the present specification is indicated by the appended claims rather than the detailed description above, and should be interpreted to include all changes or modifications derived from the meaning and the scope of the appended claims and the equivalent concepts.

### REFERENCE SIGNS LIST

1: Logistics transport and loading system
2: Collision prevention device
10: Transport robot
20: First identification camera
30: Second identification camera
100: Gripping portion
200: Gripper assembly
210: Gripper body
230: Gripping module
240: Movement guide
250: First hydraulic module

What is claimed is:

1. A collision prevention safety control system for preventing a collision with a worker or an obstacle in view of a picked-up transport object, the system comprising:
a logistics transport and loading system for automatically transport and load the transport object; and
a collision prevention device that controls an operation of the logistics transport and loading system.

2. The collision prevention safety control system of claim 1, wherein the collision prevention device controls the operation of the logistics transport and loading system in view of a probability of collision between a transport robot forming the logistics transport and loading system to transport and load the transport object and the worker or the obstacle existing within a movement range of the transport robot.

3. The collision prevention safety control system of claim 2, wherein the collision prevention device controls the operation of the logistics transport and loading system in view of the probability of collision between the transport object under transportation after being picked up by the transport robot and the worker or the obstacle existing within the movement range of the transport robot.

4. The collision prevention safety control system of claim 3, wherein the collision prevention device three-dimensionally recognizes a shape of the transport object, and thereafter, monitors the probability of collision between the transport object and the worker or the obstacle on a real-time basis.

5. The collision prevention safety control system of claim 4, wherein the collision prevention device recognizes shapes of the transport object, the worker, and the obstacle, based on 3D vision recognition using a 3D vision camera.

6. The collision prevention safety control system of claim 3, wherein the collision prevention device confirms occurrence of the collision by detecting on a real-time basis whether an impact to the transport robot or the transport object occurs during a process in which the transport object is transported by the transport robot, or confirms the occurrence of the collision through tracking recognition of a change in a fastening pressure of a gripping portion provided in the transport robot to fasten the transport object.

7. The collision prevention safety control system of claim 3, wherein the collision prevention device controls a transport speed of the transport object transported by the logistics transport and loading system in response to characteristics including a weight of the transport object.

8. The collision prevention safety control system of claim 7, wherein the collision prevention device sets a collision prevention safety area according to the transport speed of the transport object so that the collision with the transport robot or the transport object does not occur in a case of emergency braking.

9. The collision prevention safety control system of claim 8, wherein the collision prevention device reduces the transport speed of the transport object transported by the logistics transport and loading system or widely sets the collision prevention safety area as the weight of the transport object increases to prevent the collision caused by transport inertia of the transport object in a case of emergency braking.

10. The collision prevention safety control system of claim 8, wherein the collision prevention device sets the collision prevention safety area which is an area for preventing the collision during transport of the transport object fastened to the gripping portion provided in the transport robot, in view of a probability of falling-down of the transport object.
